(19) United States
(12) Patent Application Publication
(10) Pub. No.: US 2026/0200953 A1
(43) Pub. Date: Jul. 16, 2026

(54) METAL ORGANIC FRAMEWORK

(71) Applicant: Immaterial Ltd., Cambridge (GB)

(72) Inventor: Kamal DIAB, Birmingham (GB)

(21) Appl. No.: 19/134,768

(22) PCT Filed: Dec. 4, 2023
(86) PCT No.: PCT/GB2023/053128

§ 371 Date: Jun. 2, 2025

(30) Foreign Application Priority Data
Dec. 2, 2022 (GB) 2218176.2

(51) Int. Cl. C07F 5/06

(52) U.S. Cl. CPC C07F 5/069

(57) ABSTRACT

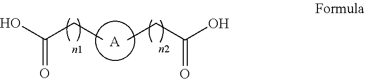

A porous metal-organic framework (MOF) comprising metal ions coordinated to linkers, wherein one or more of the linkers has the following general formula wherein A is a heteroaryl or heterocycloalkyl ring or ring system selected from a 6-membered ring or a fused multi-ring system; wherein when A is a 6-membered ring the carboxylate side chains are in the 2,5 position; and n1 and n2 are independently integers selected from the range 0 to 20. Preferably, the MOF comprises two chemically-different linkers.

This invention relates generally to water sorption-driven applications. More specifically, this invention relates to metal-organic frameworks for water sorption-driven applications.

Providing fresh water to a rapidly growing world population is a global challenge, with more than half of the world expected to experience a shortage of water by the year 2050. Of all water on earth only 2.5% is fresh water and only a small fraction of water is directly accessible in rivers and lakes (0.4%), the majority is locked up in glaciers (68.7%) or stored in groundwater (30.1%). With two thirds of the world's population experiencing water stress, it is unlikely that these sources of fresh water will suffice to address the global water problem in an energy efficient way.

Water in the atmosphere is a recyclable, natural resource and has the potential to provide water to the arid regions of the world. However, the concentration of water in the air is low and therefore, finding a way to trap this water is problematic.

Current technologies used to generate water from moist air and fog include: fog collection by means of large nets, cooling air below its dew point (the temperature at which the air is saturated with water) and sorbent-assisted water capture.

However, fog collectors require permanent high relative humidity (RH≈100%) levels and light winds to facilitate dewing on fine nets, which severely restricts the geographical areas suitable for their application. Further, whilst dewing has a much broader range of geographic applicability, its energy efficiency and water productivity are heavily dependent on the local climate. To initiate condensation, moist air needs to be cooled below the dew point through removal of the associated sensible heat (energy transfer required to cool down the air). On the other hand, the concept of adsorption-based devices has a high potential for water harvesting, even from dry air, but is strongly dependent on the performance of the adsorbent. The water uptake of classical desiccants (e.g. CaCl₂), silica gel, or zeolites) employed in such devices is high but their strong affinity to water renders their regeneration, which makes it energy intensive, thereby leading to low working capacities in autonomous devices, especially when powered by low grade energy sources.

It is therefore a first non-exclusive object of the invention to efficiently harvest water from the air.

It has been suggested previously that metal organic frameworks (MOFs) may be used to harvest water. Accordingly, it would be beneficial to develop MOFs which have better adsorption properties and/or which are more efficient in harvesting and supplying harvested water.

It is an object of this invention to provide a MOF which displays improved adsorption and/or has faster (or less energetic) desorption and/or which is operable over many adsorption/desorption cycles without deterioration.

Accordingly, a first aspect of the invention provides a porous metal-organic framework comprising metal ions coordinated to linkers, wherein one or more of the linkers has the following general formula:

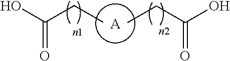

wherein A is a heteroaryl or heterocycloalkyl ring or ring system selected from a 6-membered ring or a fused multi-ring system;
wherein when A is a 6-membered ring the carboxylate side chains are in the 2,5 position; and
n1 and n2 are independently integers selected from the range 0 to 20.

In an embodiment, the metal-organic framework may comprise a mixture of different ions and/or linkers. For example the metal-organic framework may comprise one or more first linkers of the formula:

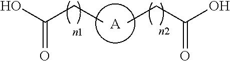

wherein A is a heteroaryl or heterocycloalkyl ring or ring system selected from a 6-membered ring or a fused multi-ring system;
wherein when A is a 6-membered ring the carboxylate side chains are in the 2,5 position; and
n1 and n2 are independently integers selected from the range 0 to 20; and one or more second linkers, the structure of the first linker and the second linker being different.

For example, the metal-organic framework may comprise one or more second linkers of the formula:

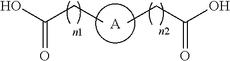

wherein A is a heteroaryl or heterocycloalkyl ring or ring system selected from a 6-membered ring or a fused multi-ring system;
wherein when A is a 6-membered ring the carboxylate side chains are in the 2,5 position; and
n1 and n2 are independently integers selected from the range 0 to 20;
wherein said one or more first linkers and said one or more second linkers have different structures.

In this specification, a different structure is one that is not chemically identical. Thus it would cover a situation in which the linkers comprise, or are composed of, different chemical entities, for example one linker may have a 5 membered ring and the other linker a 6 membered ring, and/or one may comprise one heteroatom e.g. N and the other comprises a different hetero atom e.g. S or O, or that the first linker and second linkers are isomers of one another). As an example a first linker may comprise a pyrazine moiety and the second linker may comprise a pyrimidine moiety.

A second aspect of the invention provides a porous metal-organic framework wherein the metal-organic framework comprises one or more first linkers of the formula:

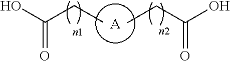

wherein A is a heteroaryl or heterocycloalkyl ring or ring system selected from a 6-membered ring or a fused multi-ring system;
wherein when A is a 6-membered ring the carboxylate side chains are in the 2,5 position; and
n1 and n2 are independently integers selected from the range 0 to 20;
and a second linker, wherein the first linker has a different structure to the second linker.

The second linker may have the following formula:

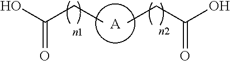

wherein A is a heteroaryl or heterocycloalkyl ring or ring system selected from a 6-membered ring or a fused multi-ring system;
wherein when A is a 6-membered ring the carboxylate side chains are in the 2,5 position; and
n1 and n2 are independently integers selected from the range 0 to 20;
wherein said one or more first linkers and said one or more second linkers have different structures.

The possibility of using different (chemical) linkers in a MOF opens up a host of possible options for tuning the properties of the MOF to particular tasks or environments.

In particular, the use of different ligands may allow for the provision of MOFs which have different and/or extended humidity range function and/or may facilitate a more energy-efficient water harvesting procedure (as may be demonstrated by reduced regeneration temperatures, for example).

A may be selected from two fused 5-membered rings or two fused 6-membered rings or a fused 5- and 6-membered ring.

The metal ions may coordinate to the one or more linkers to form a cluster, e.g. a metal carboxylate cluster.

The metal ion may be selected from zirconium, nickel, iron, copper, manganese, aluminium, magnesium, calcium, strontium, barium, titanium, zinc, indium, cadmium, hafnium, lead, cobalt and/or chromium.

Alternatively, the metal ion may be a metal compound or a metal-containing complex.

In an embodiment, all of the linkers may comprise the same general structure.

The heteroaryl or heterocycloalkyl ring A may comprise plural heteroatoms. The heteroatom(s) may be selected from nitrogen, sulphur and oxygen.

Where plural heteroatoms are present they may all be the same. Alternatively, one or more of the heteroatoms may be different from the other heteroatoms.

The heteroaryl or heterocycloalkyl ring A may be completely saturated. The heteroaryl or heterocycloalkyl ring A may be unsaturated. The heteroaryl or heterocycloalkyl ring A may comprise at least one double bond. For example, the heteroaryl or heterocycloalkyl ring A may comprise 1, 2, 3, 4 or 5 double bonds.

One or more of the linkers may have the following structure:

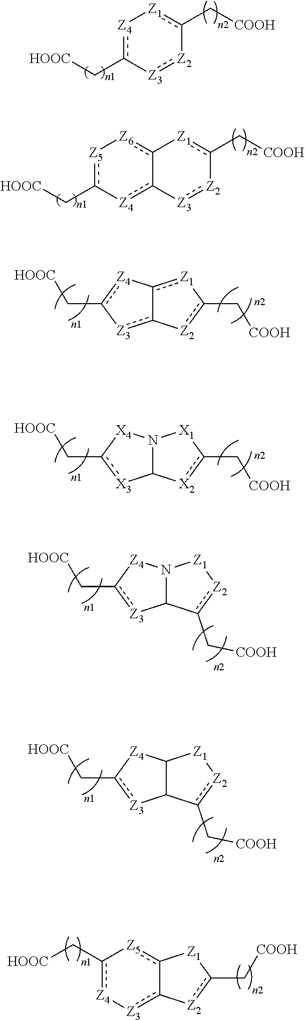

wherein at least one of Z₁, Z₂, Z₃, Z₄, Z₅ and Ze is a heteroatom; Z₁, Z₂, Z₃, Z₄, Z₅ and Z₆ are selected from N, NH, O, S, C(R₁) or C(R₁)(R₂); wherein
R₁ and R₂ are selected from H or alkyl, e.g. lower alkyl; and
n1 and n2 are independently integers selected from the range 0 to 20.

In the porous-metal organic framework according to the invention n1 and n2 may be independently selected from 0, 1, 2, 3, 4, 5, 6, 7, 8, 9, 10, 11, 12, 13, 14, 15, 16, 17, 18, 19 and 20. In an embodiment, n1 and n2 may be the same. Alternatively, n1 and n2 may be different.

In embodiments of the invention, one or more of the linkers comprises a 6-membered ring with the carboxylate side chains in the 2,5 position. We believe that such a position ensures a larger pore size in the MOF, thereby improving water absorption.

The one or more linkers may have one of the following general structures:

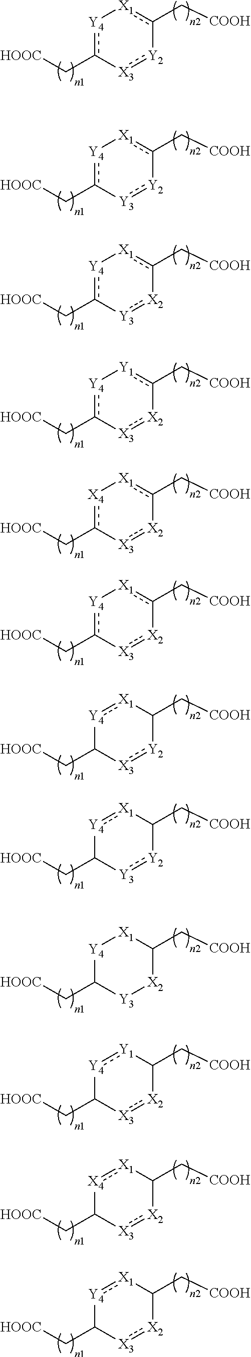

wherein X₁, X₂, X₃ and X₄ are selected from N, NH, S or O;
Y₁, Y₂, Y₃ and Y₄ are selected from C(R₁)(R₂) or C(R₁);
wherein R₁ and R₂ are selected from H or alkyl, e.g. lower alkyl; and
n1 and n2 are independently integers selected from the range 0 to 20.

For example, one or more of the linkers may have the following structure:

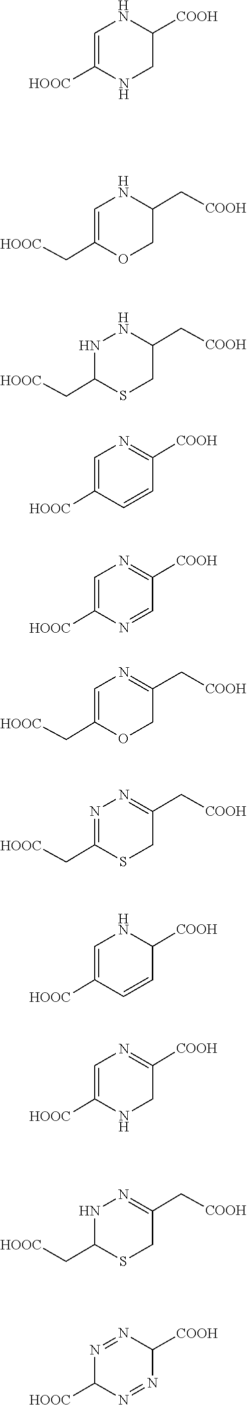

In embodiments of the invention, one or more of the linkers comprises two fused 6-membered rings.

The one or more linkers may have one of the following general structures:

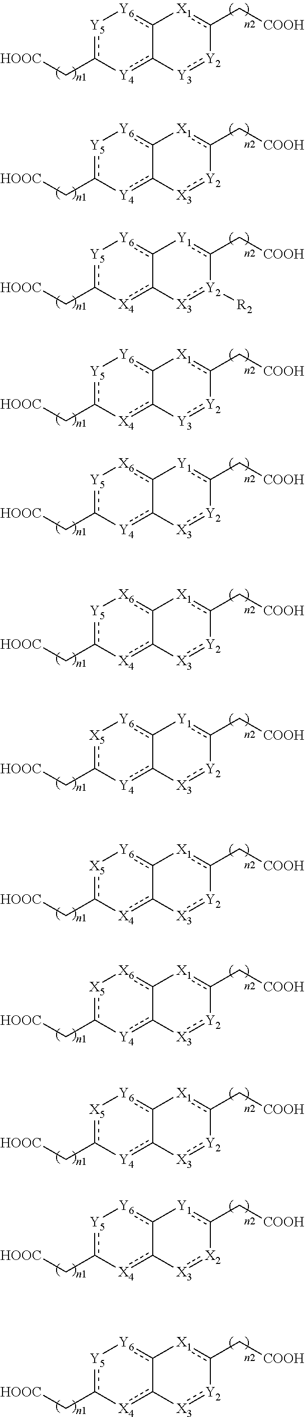

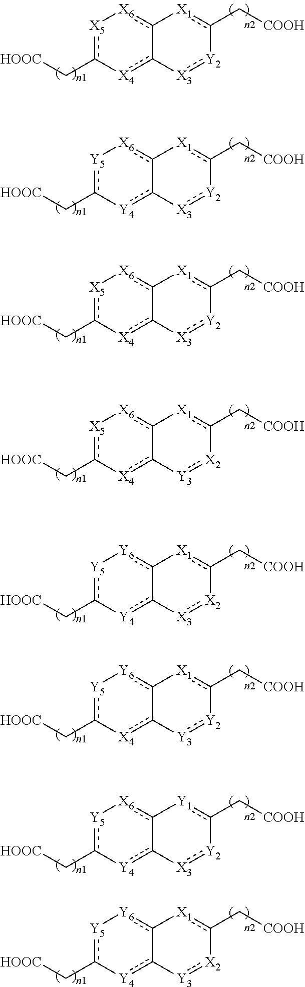

wherein X₁, X₂, X₃, X₄, X₅ and X₆ are selected from N, NH, O and S;
Y₁, Y₂, Y₃, Y₄, Y₅ and Y₆ are selected from C(R₁)(R₂) or C(R₁);
wherein R₁ and R₂ are selected from H or alkyl, e.g. lower alkyl; and
n1 and n2 are independently integers selected from the range 0 to 20.

In embodiments of the invention, one or more of the linkers comprises two fused 5-membered rings.

The one or more linkers may have one of the following general structures:

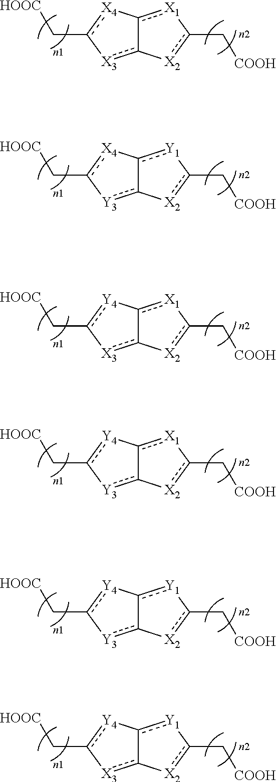

wherein X₁, X₂, X₃ and X₄ are selected from N, NH, O and S;
Y₁, Y₂, Y₃ and Y₄ are selected C(R₁)(R₂) or C(R₁);
wherein R₁ and R₂ are selected from H or alky; and
n1 and n2 are independently integers selected from the range 0 to 20.

The one or more linkers may have one of the following general structures:

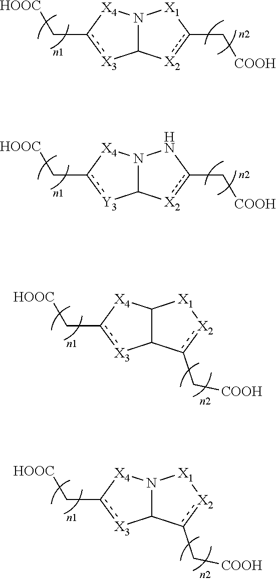

wherein X₁ and X₄ are selected from NH, O and S;
X₂ and X₃ are selected from NH, N, O and S; and
n1 and n2 are independently integers selected from the range 0 to 20.

The one or more linkers may have one of the following general structures:

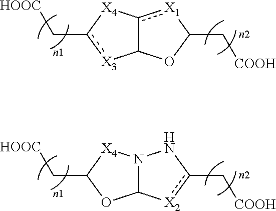

wherein X₁, X₂ and X₃ are selected from N, NH, O and S;
X₄ is selected from NH, O and S; and
n1 and n2 are independently integers selected from the range 0 to 20.

For example, one or more of the linkers may have the following structure:

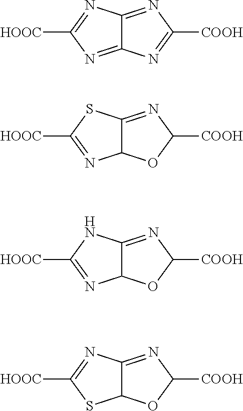 [SMILES: O=C(O)C1=NC2=NC(C(=O)O)=NC2=N1 ; O=C(O)C1=NC2OC(C(=O)O)N=C2S1 ; O=C(O)C1=NC2OC(C(=O)O)N=C2N1 ; O=C(O)C1=NC2=NC(C(=O)O)OC2S1]

One or more of the linkers may comprise a fused 5- and 6-membered ring.

The one or more linkers may have one of the following general structures:

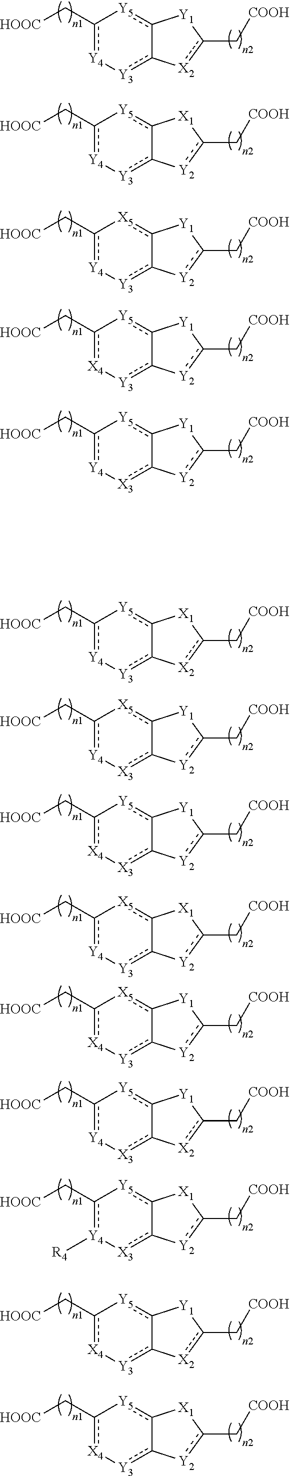

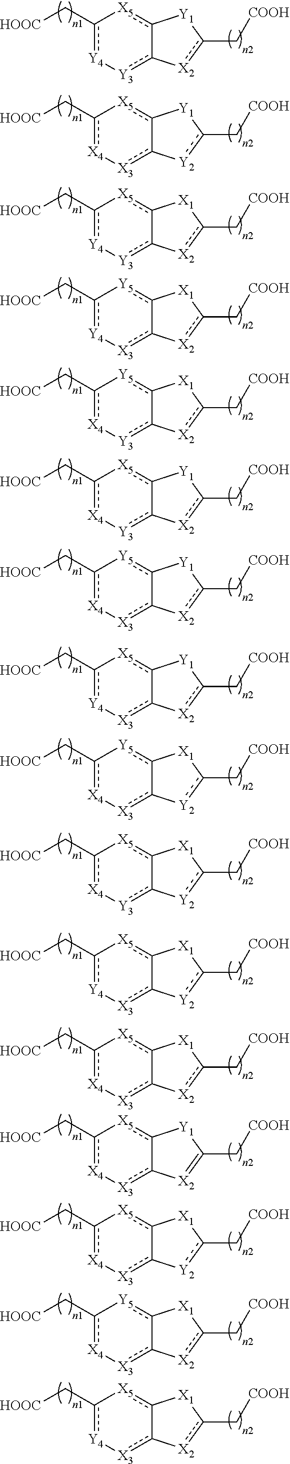

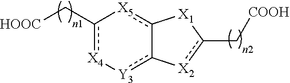

wherein X₁ is selected from NH, O or S;
X₂, X₃, X₄ and X₅ are selected from NH, N, O and S;
Y₁ is C(R₁)(R₂);
Y₂, Y₃, Y₄, Y₅ and Y₆ are selected from C(R₁)(R₂) or C(R₁);
wherein R₁ and R₂ are selected from H or alkyl, e.g. lower alkyl; and
n1 and n2 are independently integers selected from the range 0 to 20.

The porous metal-organic framework may have a permanent porosity.

Adsorbates such as water, fuel or gases (e.g. SOx, NOx, hydrocarbons, flue gases, methane, hydrogen) may be capable of being housed in the pores of the porous metal-organic framework.

The porous metal-organic framework may have a pore volume of greater than 0.20 cm³g⁻¹, e.g. greater than 0.25, 0.30, 0.35, 0.40, 0.45, 0.50 or 0.55 cm³g⁻¹, for example the porous metal-organic framework has a pore volume in the range 0.20 to 2.00 cm³g⁻¹, e.g. 0.20 to 1.50 or 0.25 to 1.00 or 0.30 to 0.70, 0.40 to 0.60 or 0.50 to 0.65 cm³g⁻¹.

The porous metal-organic framework may comprise a Brunauer-Emmett-Teller (BET) surface area in the range 500 to 6000 m²g⁻1, for example 500 to 5500, 500 to 5000, 500 to 4500, 500 to 4000, 500 to 3500, 500 to 3000, 500 to 2500, 500 to 2000, 500 to 1500, 800 to 1500 or 900 to 1400 m²g⁻¹.

A gravimetric water uptake of the porous metal-organic framework at 90% relative humidity and an adsorption temperature of 25° C., may be greater than 20 wt. %, e.g. greater than 25, 30, 35, 40, 35, 50, 55, 60, 65 or 70 wt. %, for example in the range 20 to 80 wt. %, e.g. 20 to 70, 30 to 65, 40 to 60 or 45 to 60 wt. %.

The volumetric water uptake of the metal-organic framework at 20% relative humidity may be greater than 0.30 g_{water}/cm³, e.g. greater than 0.35, 0.40, 0.45, 0.50, 0.55, 0.60, 0.65, 0.70, 0.75, 0.80, 0.85 or 0.90 g_{water}/cm³.

The bulk density of the porous metal-organic framework may be in the range 0.80 to 1.20 g/cm³, e.g. 0.90 to 1.10 g_{water}/cm³, for example 0.90, 0.91, 0.92, 0.93, 0.94, 0.95, 0.96, 0.97, 0.98, 0.99, 1.00, 1.01, 1.02, 1.03, 1.04, 1.05, 1.06, 1.07, 1.08, 1.09 or 1.10 g/cm³.

The porous metal-organic framework may be fully regenerated at temperatures in the range 25 to 90° C., e.g. at 30, 35, 40, 45, 50, 55, 60, 65, 70, 75, 70, 85 or 90° C.

Advantageously the porous metal-organic frameworks according to the invention provide a diverse array of structures which allows for the necessary chemical and geometrical optimization required to achieve the desired water sorption properties.

Further, the porous metal-organic frameworks according to the invention have a high chemical stability to water, tailorable hydrophilicity and hydrophobicity, adjustable pore diameter and the adsorption profile may be fine-tuned and the sorption kinetics modulated.

According to a further aspect of the invention there is provided a cluster for a metal organic framework, the cluster comprising metal ions coordinated to one or more linkers, wherein one or more of the linkers has the following general formula:

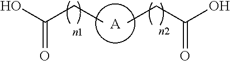

wherein A is a heteroaryl or heterocycloalkyl ring or ring system selected from a 6-membered ring or a fused multi-ring system;
wherein when A is a 6-membered ring the carboxylate side chains are in the 2,5 position; and
n1 and n2 are independently integers selected from the range 0 to 20.

According to a further aspect of the invention there is provided a cluster for a metal organic framework, the cluster comprising metal ions coordinated to one or more linkers, wherein said one or more linkers comprises at least one first linker of the formula:

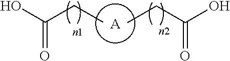

wherein A is a heteroaryl or heterocycloalkyl ring or ring system selected from a 6-membered ring or a fused multi-ring system;
wherein when A is a 6-membered ring the carboxylate side chains are in the 2,5 position; and
n1 and n2 are independently integers selected from the range 0 to 20;
and at least one second linker, wherein the first linker has a different structure to the second linker.

For example, the said at least one second linker may have the following formula:

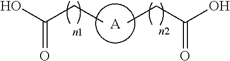

wherein A is a heteroaryl or heterocycloalkyl ring or ring system selected from a 6-membered ring or a fused multi-ring system;
wherein when A is a 6-membered ring the carboxylate side chains are in the 2,5 position; and
n1 and n2 are independently integers selected from the range 0 to 20

A may be selected from two fused 5-membered rings or two fused 6-membered rings or a fused 5- and 6-membered ring.

The cluster of these embodiments is a metal carboxylate cluster. The clusters are joined together by the ligands to form a crystalline porous framework.

According to a further aspect of the invention, there is provided a method of synthesising a porous metal-organic framework, the method comprising:
a) dissolving metal ions and linkers in water, wherein one or more of the linkers has the following general formula:

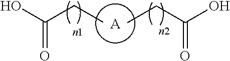

wherein A is a heteroaryl or heterocycloalkyl ring or ring system selected from a 6-membered ring or a fused multi-ring system;
wherein when A is a 6-membered ring the carboxylate side chains are in the 2,5 position; and
n1 and n2 are independently integers selected from the range 0 to 20; and
b) adding a Brønsted-Lowry base, e.g. NaOH, LiOH, triethylamine, to the mixture; and
c) heating the mixture to produce a crystalline material.

In an embodiment said linkers dissolved in water may comprise linkers having different structures.

A may be selected from two fused 5-membered rings or two fused 6-membered rings or a fused 5- and 6-membered ring.

The metal ion may be selected from zirconium, nickel, iron, copper, manganese, aluminium, magnesium, calcium, strontium, barium, titanium, zinc, indium, cadmium, hafnium, lead, cobalt, and/or chromium.

Alternatively, the metal ion may be a metal compound or a metal-containing complex.

One or more of the linkers may be a linker as described herein.

Step (c) may comprise heating the mixture to a temperature in the range 30 to 100° C., e.g. 30, 35, 40, 45, 50, 55, 60, 65, 70, 75, 80, 85, 90, 95 or 100° C.

Step (c) may comprise heating the mixture from 4 to 72 hours, e.g. 24 hours.

The method may further comprise activating the porous metal-organic framework, comprising:
(i) soaking the crystalline material in deionised water;
(ii) soaking the crystalline material in methanol; and
(iii) heating the crystalline material.

Step (i) and/or step (ii) may comprise soaking the crystalline material for a period of 4 mins to 24 hours.

Step (iii) may comprise heating the crystalline material to 40 to 100° C. for 1 min to 2 hours, then to 40 to 150° C. for 10 min to 2 hours, then to 60° C. for 10 min to 2 hours.

Whilst we have disclosed that MOFs of the invention may comprise linkers or ligands having different structures, the method of the invention uses the same metal centre and provides a convenient ‘green’ method for fabricating MOFs, using water as the principal solvent which can exploit different linkers to provide MOFs having tunable properties to facilitate the exploitation of MOFs in different environments (i.e. different humidities, temperatures and so on).

The following explanations of terms and methods are provided to better describe the present compounds and methods, and to guide those of ordinary skill in the art in the practice of the present disclosure. It is also to be understood that the terminology used in the disclosure is for the purpose of describing particular embodiments and examples only and is not intended to be limiting.

The term “alkyl” refers to a branched or unbranched saturated hydrocarbon group of 1 to 24 carbon atoms, such as methyl, ethyl, n propyl, isopropyl, n butyl, isobutyl, t butyl, pentyl, hexyl, heptyl, octyl, decyl, tetradecyl, hexadecyl, eicosyl, tetracosyl and the like. A “lower alkyl” group is a saturated branched or unbranched hydrocarbon having from 1 to 10 carbon atoms. Alkyl groups may be “substituted alkyls” wherein one or more hydrogen atoms are substituted with a substituent such as halogen, cycloalkyl, alkoxy, amino, hydroxyl, aryl, or carboxyl.

The term “cycloalkyl” refers to a non-aromatic carbon-based ring composed of at least three carbon atoms. Examples of cycloalkyl groups include, but are not limited to, cyclopropyl, cyclobutyl, cyclopentyl, cyclohexyl, and the like. The term “heterocycloalkyl group” is a cycloalkyl group as defined above where at least one of the carbon atoms of the ring is substituted with a heteroatom such as, but not limited to, nitrogen, oxygen, sulfur, or phosphorous.

The term “aryl” refers to any group derived from an aromatic group including, but not limited to, a benzene ring or to an optionally substituted benzene ring system fused to one or more optionally substituted benzene rings. A “heteroaryl group” is defined as an aryl group that has at least one heteroatom incorporated within the ring of the aryl group. Examples of heteroatoms include, but are not limited to, nitrogen, oxygen and sulphur.

A cluster refers to a chemical entity that connects ditopic ligands in a 3D structure to each other.

It is to be understood that each of the atoms have the correct bond valency. For example, carbon forms 4 bonds, nitrogen forms 3 bonds and oxygen and sulphur each form 2 bonds.

Accordingly, the bonds represented by ----- may be a single or double bond, such that each atom has the correct bond valency.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. For the avoidance of doubt, the terms “may”, “and/or”, “e.g.”, “for example” and any similar term as used herein should be interpreted as non-limiting such that any feature so-described need not be present. Indeed, any combination of optional features is expressly envisaged without departing from the scope of the invention, whether or not these are expressly claimed. The applicant reserves the right to change any originally filed claim or file any new claim accordingly, including the right to amend any originally filed claim to depend from and/or incorporate any feature of any other claim although not originally claimed in that manner.

Embodiments of the invention will now be described by way of example only with reference to the accompanying drawings in which:

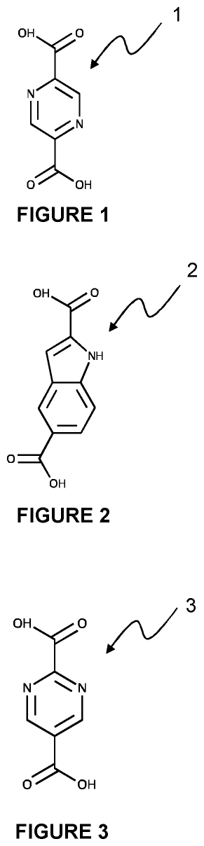

FIG. 1 shows a pyrazine ligand used in synthesising a MOF according to the invention;

FIG. 2 shows an indole ligand used in synthesising a MOF according to the invention;

FIG. 3 shows a pyrimidine ligand used in synthesising a MOF according to the invention;

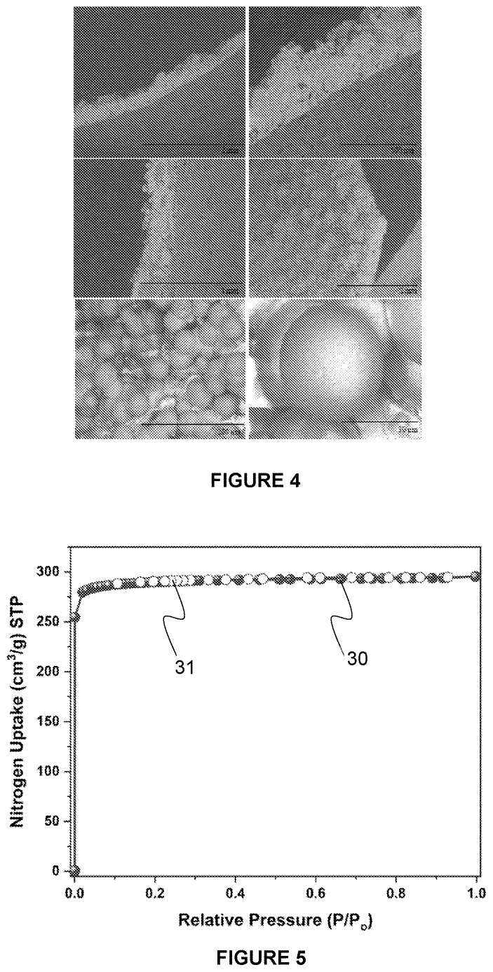

FIG. 4 shows scanning electron microscope images of a MOF according to the invention;

FIG. 5 is a graph showing nitrogen adsorption and desorption for surface area measurement of a MOF according to the invention;

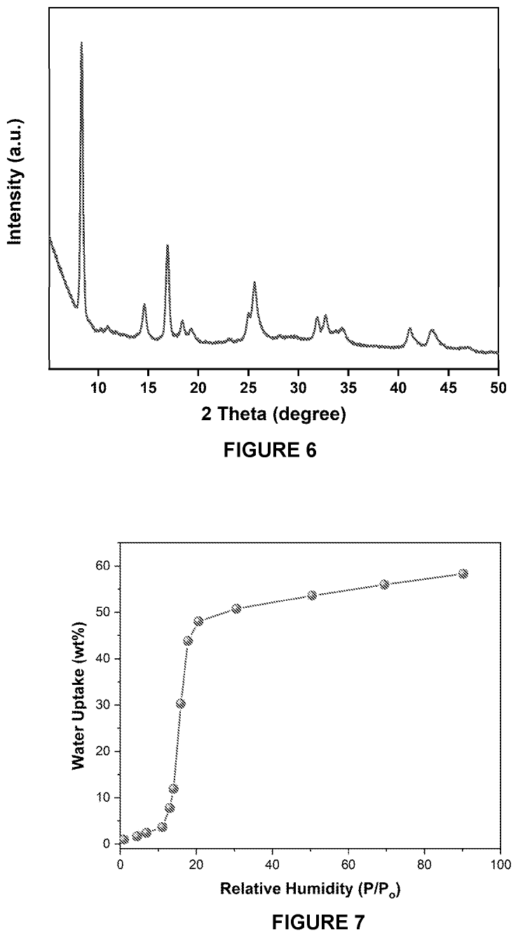

FIG. 6 is a powder x-ray diffraction pattern of a MOF according to the invention;

FIG. 7 is a graph displaying the gravimetric water uptake isotherm of a MOF according to the invention;

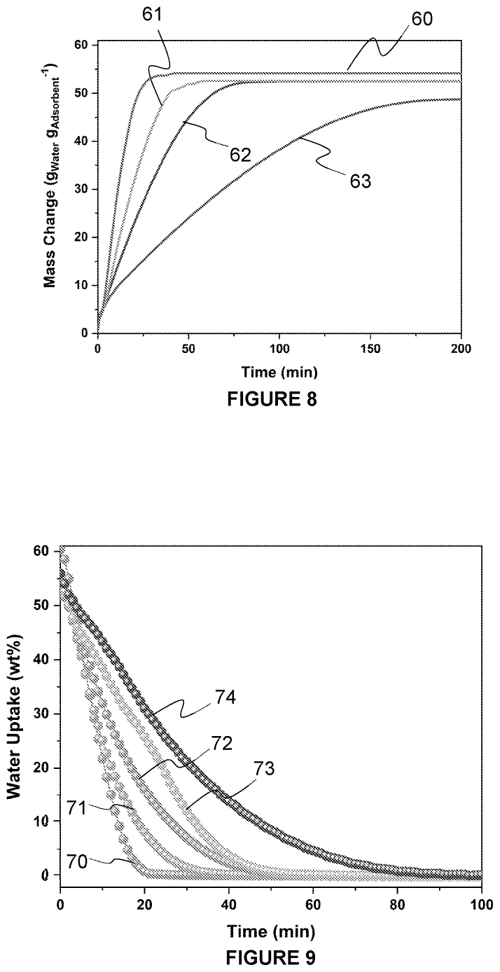

FIG. 8 is a graph displaying the water adsorption kinetics of a MOF according to the invention;

FIG. 9 is a graph displaying the water desorption kinetics of a MOF at different temperatures.

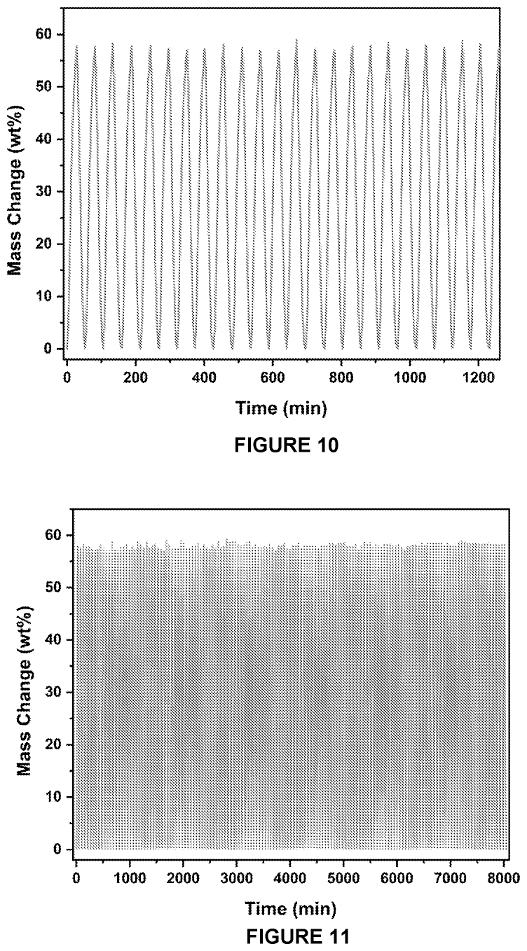

FIG. 10 is a graph showing the cyclic stability of a MOF according to the invention;

FIG. 11 is a graph showing the cyclic stability of a MOF according to the invention;

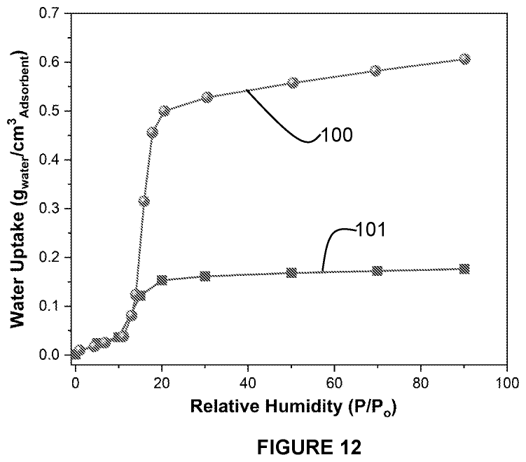

FIG. 12 is a graph showing the water volumetric uptake of a MOF according to the invention compared to a known MOF;

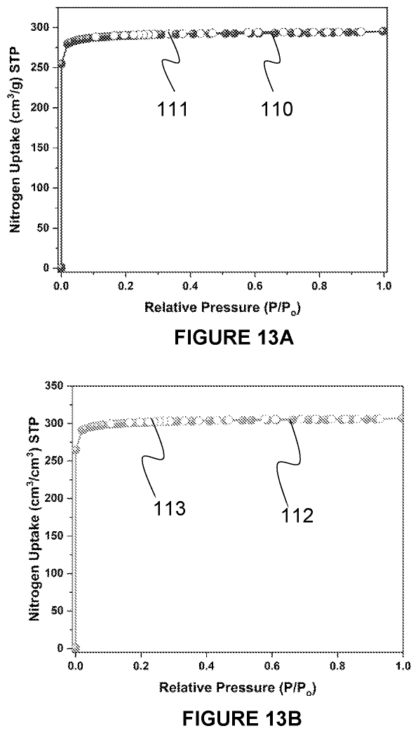

FIG. 13A is a graph showing the nitrogen adsorption and desorption for gravimetric surface area measurement of a MOF according to the invention;

FIG. 13B is a graph showing the nitrogen adsorption and desorption for volumetric surface area measurement of a MOF according to the invention; and

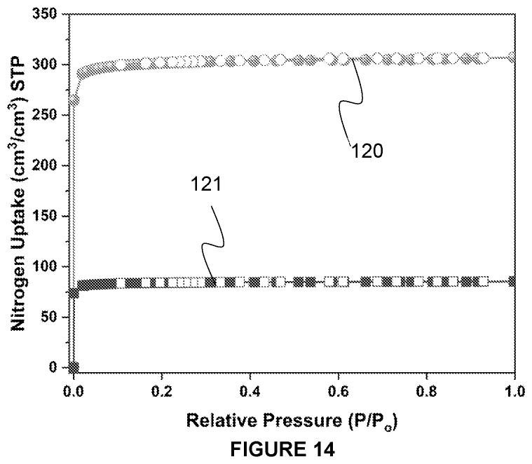

FIG. 14 is a graph showing the nitrogen gas volumetric uptake of a MOF according to the invention compared to a known MOF;

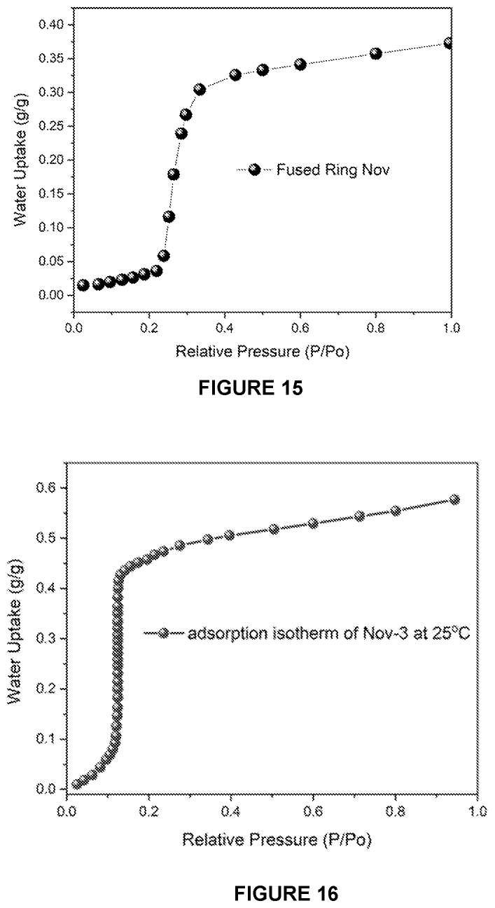

FIG. 15 is a graph displaying the gravimetric water uptake isotherm of a MOF according to the invention;

FIG. 16 is a graph displaying the gravimetric water uptake isotherm of a MOF according to the invention;

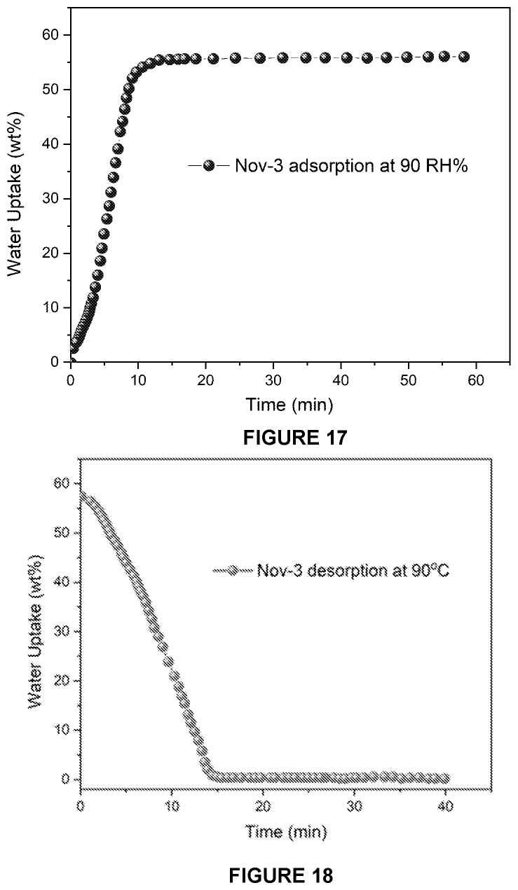

FIG. 17 is a graph displaying the water adsorption kinetics of a MOF according to the invention;

FIG. 18 is a graph displaying graph displaying the water desorption kinetics of a MOF according to the invention.

Referring to FIG. 1, there is shown a pyrazine linker, 2,5 pyrazine dicarboxylic acid linkers 1, used in forming a MOF according to the invention.

The 2,5 pyrazine dicarboxylic acid linkers 1 each coordinate to aluminium ions, forming an aluminium oxide cluster, resulting in the creation of a MOF which we call Nov-1.

Referring to FIG. 2, there is shown an indole linker, 1H indole 2,5 dicarboxylic acid linkers 2, used in forming a MOF according to the invention.

The 1H indole 2,5 dicarboxylic acid linkers 2 each coordinate to aluminium ions, forming an aluminium oxide cluster, resulting in the creation of a MOF which we call Nov-2.

Referring to FIG. 3, there is shown a pyrimidine linker, 2,5 pyrimidine dicarboxylic acid linkers 3, used in combination with linkers 1 (FIG. 1), both of which coordinate to aluminium ions, forming aluminium oxide clusters, resulting in the creation of a single MOF which we call Nov-3.

### Synthesis and Activation of MOFs

The synthetic procedures were conducted in open air, as follows:

### Synthesis of Nov-1

Nov-1: 5.2 g aluminium chloride hexahydrate (AlCl₃·6H₂O) and 3.62 g 2,5 pyrazine dicarboxylic acid were dissolved in 375 ml water in a 500 ml glass bottle. Subsequently, LiOH (1.5 g) was added to the above mixture. The glass bottle was then sealed and heated in 100° C. isothermal oven for between 4 and 20 hours, resulting in a brown round-shaped (50 μm×50 μm×20 μm) crystallised material, as observed by scanning electron microscopy (SEM), see FIG. 2).

Activation of MOFs: The as-synthesized crystalline material powder (e.g. non-activated Nov-1) was soaked in deionised water for 4 min to one day (~24 hours) before being soaked in methanol for 4 min to one day (~24 hours). The crystalline material (e.g. non-activated Nov-1) was then heated up to 40 to 100° C. for 4 min to 2 hours, before being ramped up to 150° C. for 4 min to 2 hours and finally the temperature was ramped up to 40 to 160° C. for 4 min to 2 hours to produce the activated sample (e.g. activated Nov-1).

The apparent surface area of the Nov-1 MOF was determined from nitrogen adsorption-desorption isotherms collected at 77K on a Micromeritics Tristar II 3020 with the temperature held constant using a liquid nitrogen bath.

The Nov-1 MOF has a permanent porosity, a Brunauer-Emmett-Teller (BET) surface area of 1380 m²g⁻¹ and a pore volume of 0.55 cm³ g⁻¹ (see FIG. 3; nitrogen adsorption 30 and nitrogen desorption 31).

### Synthesis of Nov-2

Nov-2:0.8 g of lithium chloride and 2.1 g⁻¹H indole 2,5 dicarboxylic acid were dissolved in 300 ml water. Subsequently, 4.6 g of aluminium chloride hexahydrate (AlCl₃·6H₂O) was added to the above mixture, resulting in the formation of a white precipitate. The reaction mixture was then heating at 120 C for 21 hours. The resultant crystals were then subjected to triple washes with distilled water and methanol, followed by drying at 140° C. for 12 hours.

### Synthesis of Nov-3

Nov-3:1.6 g of lithium hydroxide and 2 g of pyrimidine 2,5 dicarboxylic acid were dissolved in 750 ml water. Subsequently, 5.5 g of pyrazine 1,5 dicarboxylic acid was added to the reaction mixture and sonicated for 3 minutes. 10.4 g of aluminium chloride hexahydrate (AlCl₃·6H₂O) was added to the mixture and heated at 120° C. for 21 hours. The resultant crystals were then subjected to triple washes with distilled water and methanol, followed by drying at 140° C. for 12 hours.

The MOFs were synthesised using water as a solvent without centrifugation, densification, applied pressure, or binders.

The use of different ligands (and indeed even mixes of ligands) shows the utility of the method to produce MOFs having different properties.

In alternative embodiments, the MOF synthesis may comprise aluminium sulphate, e.g. aluminium sulphate octahydrate, aluminium acetylacetonate, or aluminium acetate as the aluminium source. Of course, different salts of different metals may also be used.

Adsorbates such as water, fuel or gases (including SOₓ, NOₓ, hydrocarbons, methane, hydrogen and flue gases), may be housed in the pores of the MOFs.

### EXPERIMENTAL METHODS

Referring to FIG. 4, there is shown a powder x-ray diffraction (PXRD) pattern of the Nov-1 MOF. Nov-1 represents a crystalline robust structure as shown from the sharp peaks of the PXRD.

Powder X-ray diffraction (PXRD) data was collected at room temperature on a D8 Bruker X-ray powder diffractometer, (CuKα1 radiation, λ=1.54056 Å). The line focused Cu X-ray tube was operated at 40 kV and 40 mA. Intensity data for 2θ from 5 to 50 degree were collected over a period of 30 mins.

The water sorption characteristics of the MOFs were measured using a home-made dynamic vapour sorption gravimetric analyzer by placing 15-20 g in a sample pan controlled with a mass scale. Samples were evacuated for 6 hrs. before starting the measurements.

The measurements were carried out in a relative pressure range from 0 to 0.9 at temperatures of 25° C., 30 C and 45° C. The desorption temperatures varied between 90° C. and 27° C.

In order for the invention to be more fully understood, reference is made to the following non-limiting Examples:

### Example 1

According to a first example of the invention, there is shown a graph displaying the gravimetric water uptake of Nov-1 at a relative humidity (RH) of up to 90% at an adsorption temperature of 25° C. (see FIG. 7). The data shows that Nov-1 has a steep water uptake, with the water uptake increasing from ~11 wt. % at 10% RH to ~51.2 wt. % at 20% RH. Water uptake increases further as RH increases reaching a maximum value of 60 wt. % at 90% RH.

### Example 2

According to a second example of the invention, there is shown a graph displaying the adsorption kinetics of Nov-1 at different RHs with a constant adsorption temperature of 25° C. (see FIG. 8). At 60% RH (line 60) Nov-1 reached a fully saturated state with a water uptake of 54 wt. % in under 25 minutes. At 40% RH (line 61) and 30% RH (line 62), Nov-1 achieved similar water uptake capacities of ~52 wt. % in 50 and 75 minutes, respectively. At 20% RH (line 63), Nov-1 reached a water uptake capacity of 48 wt. % in 150 minutes.

### Example 3

According to a third example of the invention, there is shown a graph displaying the desorption kinetics of Nov-1 at different temperatures in dry conditions (see FIG. 9). At 90° C. (line 70), Nov-1 reached full desorption after ~20 minutes. At 65° C. (line 71) desorption temperature, it took Nov-1~30 minutes to reach full desorption. At 55° C. (line 72), Nov-1 reached full desorption after ~42 minutes. At 45° C. (line 73), Nov-1 reached full desorption after ~50 minutes. At 27° C. (line 74) desorption temperature, it took Nov-1~80 minutes to reach full desorption.

### Example 4

According to a fourth example of the invention, there is shown the cyclic stability of Nov-1 at 90% RH and an adsorption temperature of 25° C. (see FIG. 10). The Nov-1 MOF was contacted with air (for ~28 mins), until it became fully saturated with water vapour. The Nov-1 MOF was then heated at 90° C. (for ~20 mins) to fully desorb the captured water. The Nov-1 MOF is fully regenerated, with no decrease in performance over 24 cycles (see FIG. 10).

### Example 5

Kinetic cycling performance tests show that the Nov-1 MOFs do not decrement in performance for up to 160 cycles, ~58 wt. % delivery capacity under the following conditions: adsorption in 90% RH for 28 minutes, desorption in dry environment at 90° C. for 20 mins, demonstrating high capacity and high stability of the Nov-1 MOF (see FIG. 11).

### Comparative Example 1

According to a comparative example of the invention, there is shown a comparison of the water volumetric uptake for Nov-1 (line 100), and MOF-303 (line 101) at different RH values at 25° C. (see FIG. 12). The data shows that Nov-1 reaches volumetric uptake of 0.54 g_{water}/cm³ at 20% RH, whereas MOF-303 only manages to reach 0.15 g_{water}/cm³. The maximum volumetric uptake reached for Nov-1 (line 100) and MOF-303 (line 101) is 0.64 water/cm³, and 0.16 g_{water}/cm³, respectively. The high volumetric uptake of Nov-1 is as a result of its high bulk density. Nov-1 shows very high density reaching 1.04 g/cm³ while no decrease on the adsorption behaviour, maintaining the volumetric water uptake the same as powder and single crystal.

### Example 6

According to further example of the invention, there is shown the BET surface area measurements of Nov-1 MOF showing gravimetric uptake (FIG. 13A; nitrogen adsorption 110 and nitrogen desorption 111), and volumetric uptake (FIG. 13B; nitrogen adsorption 112 and nitrogen desorption 113). Nov-1 shows very high density with no decrease on the gas sorption behaviour, maintaining the porosity and the gas volumetric uptake the same as powder and single crystal.

### Comparative Example 2

According to a comparative example of the invention, there is shown a comparison of the nitrogen gas volumetric uptake (FIG. 14) of Nov-1 MOF (line 120) and MOF-303 (line 121). Nov-1 has a steep nitrogen uptake compared to MOF-303.

### Comparative Example 3

Nov-1 MOF provides high capacity compared to other known materials, e.g. MOF-303 and MOF-573, at 10-90% RH, which provides an integral part in atmospheric water generation (AWG) and heat pump (HP) (or named thermal batteries) devices.

### Comparative Example 4

Nov-1 MOF provides high volumetric gas uptake capacity compared to other known porous materials such as MOF-303.

### Example 7

According to a seventh example of the invention, there is shown a graph displaying the gravimetric water uptake of Nov-2 at a RH of up to 100% at an adsorption temperature of 25° C. (see FIG. 15). The data shows that Nov-2 has a steep water uptake, with the water uptake increasing from ~4 wt. % at RH=20% to ~30 wt. % at RH=30%. Water uptake increases further as RH increases, reaching a maximum value of ~37 wt. % at RH=100%.

The ligand employed is 1H-Indole-2,5-dicarboxylic acid (5-Carboxyindole-2-carboxylic acid), having a fused 5-6 membered ring structure wherein the five-membered ring is pyrrole, and the six-membered ring is benzene. The carboxylic groups are positioned at 2 and 5, resulting in an enlarged pore size and facilitating binding of the carboxylic groups with aluminium metal clusters, thereby forming a stable structure. The ligand is comprised of two components: a hydrophilic portion containing a nitrogen atom within the pyrrole ring and a hydrophobic segment provided by the benzene ring. This configuration enables an appropriate heat of adsorption and enhances desorption kinetics.

### Example 8

According to an eighth example of the invention, there is shown a graph displaying the gravimetric water uptake of Nov-3 at a RH of up to 90% at an adsorption temperature of 25° C. (see FIG. 16). The data shows that Nov-3 has a steep water uptake with the water uptake increasing from ~10 wt. % at RH=10% to ~44 wt. % at RH=17%. Water uptake increases further as RH increases, reaching a maximum value of ~55 wt. % at RH=90%.

### Example 9

According to a ninth example of the invention, there is shown a graph displaying the adsorption kinetics of Nov-3 at RH=90% with a constant adsorption temperature of 25° C. (see FIG. 17). At RH=90% rapid adsorption kinetics are observed, with Nov-3 reaching a fully saturated state with a water uptake of 55 wt. % within just 10 minutes.

Although we do not wish or intend to be bound by any particular theory, we believe that the use of different ligands facilitates the steep water adsorption properties.

### Example 10

According to a tenth example of the invention, there is shown a graph displaying the rapid desorption kinetics of Nov-3 at 90° C. in dry conditions (see FIG. 18). Rapid desorption kinetics are observed, with Nov-3 reaching full desorption within just 15 minutes.

The simple synthesis procedure and high scalability of these MOFs make them suitable for use in various applications, including:
atmospheric water generation (AWG);
gas storage & separation: hydrogen, methane, COₓ, NOₓ, SOₓ, krypton, xenon, nitrogen, argon, oxygen, arsine;
water harvesting from air;
heat pump (HP) or thermal batteries for cooling and water desalination;
heat pump (HP) for ice formation using alcohol substances;
drug delivery;
membrane-filtration in water desalination;
nerve agent detoxification;
proton conduction in fuel cells;
energy storage;
catalytic CO₂ conversion; and
water treatment

It will be appreciated by those skilled in the art that any number of combinations of the aforementioned features and/or those shown in the appended drawings provide clear advantages over the prior art and are therefore within the scope of the invention described herein.

1. A porous metal-organic framework comprising metal ions coordinated to linkers, wherein the linkers comprise:
at least one first linker that has the following general formula: 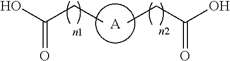
wherein A is a heteroaryl or heterocycloalkyl ring or ring system selected from a 6-membered ring or a fused multi-ring system;
wherein, when A is a 6-membered ring, the carboxylate side chains are in the 2,5 position; and
wherein n1 and n2 are integers independently selected from the range 0 to 20; and
at least one second linker that has a different structure from the at least one first linker.

2. (canceled)

3. A porous metal-organic framework according to claim 1, wherein the at least one second linker has the following general formula: 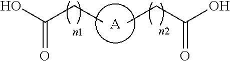
wherein A is a heteroaryl or heterocycloalkyl ring or ring system selected from a 6-membered ring or a fused multi-ring system;
wherein, when A is a 6-membered ring, the carboxylate side chains are in the 2,5 position; and
wherein n1 and n2 are integers independently selected from the range 0 to 20.

4. A porous metal-organic framework according to claim 1, wherein, for at least one of the linkers, A is selected from two fused 5-membered rings or two fused 6-membered rings or a fused 5- and 6-membered ring.

5. A porous metal-organic framework according to claim 1, wherein the metal ions are selected from the group consisting of zirconium, nickel, iron, copper, manganese, aluminum, magnesium, calcium, strontium, barium, titanium, zinc, indium, cadmium, hafnium, lead, cobalt, chromium, and combinations thereof.

6. A porous metal-organic framework according to claim 1, wherein the heteroaryl or heterocycloalkyl ring A comprises plural heteroatoms.

7. A porous metal-organic framework according to claim 6, wherein the plural heteroatoms are selected from nitrogen, sulfur, and oxygen.

8. (canceled)

9. A porous metal-organic framework according to claim 1, wherein the linkers comprise the following structures: 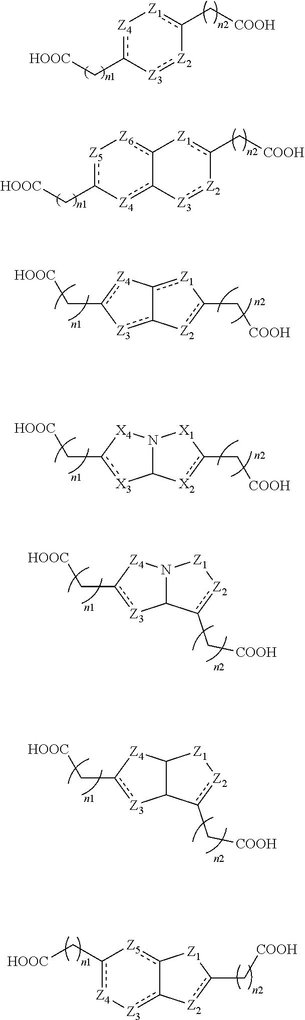
wherein at least one of Z₁, Z₂, Z₃, Z₄, Z₅, and Z₆ is a heteroatom;
wherein Z₁, Z₂, Z₃, Z₄, Z₅, and Z₆ are selected from N, NH, O, S, C(R₁), or C(R₁)(R₂);
wherein R₁ and R₂ are selected from H or alkyl; and
wherein n1 and n2 are integers independently selected from the range 0 to 20.

10. A porous metal-organic framework according to claim 1, wherein n1 and n2 are the same integer.

11. A porous metal-organic framework according to claim 1, wherein one or more of the linkers has a structure selected from the following structures:

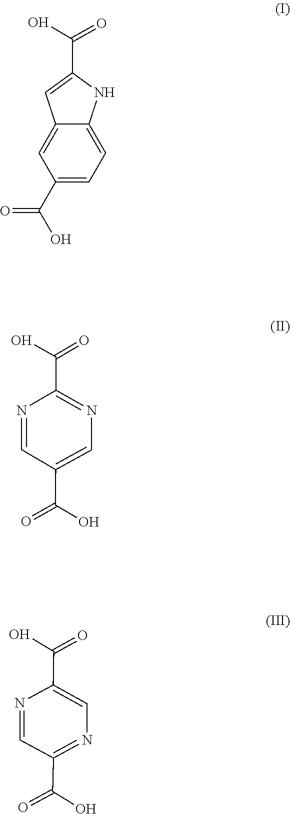 [SMILES: O=C(O)c1ccc2[nH]c(C(=O)O)cc2c1 ; O=C(O)c1cnc(C(=O)O)nc1 ; O=C(O)c1cnc(C(=O)O)cn1]

12. A porous metal-organic framework according to claim 11, wherein the at least one first linker has selected from one of structure (I), (II), or (III), and wherein the at least one second linker has another of structure (I), (II), or (III).

13-14. (canceled)

15. A porous metal-organic framework according to claim 1, wherein the porous metal-organic framework has at least one of:
a pore volume of greater than 0.20 cm³g⁻¹; and
a Brunauer-Emmett-Teller (BET) surface area in the range 500 to 6000 m²g⁻¹.

16. (canceled)

17. A porous metal-organic framework according to claim 1, wherein at least one of the following conditions is satisfied:
(i) a gravimetric water uptake of the porous metal-organic framework at 90% relative humidity and an adsorption temperature of 25° C. is greater than 20 wt. %;
(ii) a volumetric water uptake of the porous metal-organic framework at 20% relative humidity is greater than 0.30 g_{water}/cm³;
(iii) a bulk density of the porous metal-organic framework is in the range 0.80 to 1.20 g/cm³; and
(iv) the porous metal-organic framework is fully regenerated at temperatures in the range 25 to 90° C.

18-20. (canceled)

21. A method of synthesizing a porous metal-organic framework, the method comprising:
(a) dissolving metal ions and plural chemically different linkers in water to form a mixture, wherein one or more of the linkers has the following general formula: 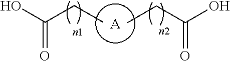
wherein A is a heteroaryl or heterocycloalkyl ring or ring system selected from a 6-membered ring or a fused multi-ring system;
wherein when A is a 6-membered ring the carboxylate side chains are in the 2,5 position; and
wherein n1 and n2 are integers independently selected from the range 0 to 20;
(b) adding a Brønsted-Lowry base to the mixture; and
(c) heating the mixture to produce a crystalline material.

22. (canceled)

23. A method according to claim 21, wherein step (a) comprises dissolving in water, as one of the plural chemically different linkers, a first linker having the following general formula: 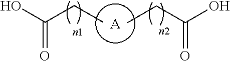
wherein A is a heteroaryl or heterocycloalkyl ring or ring system selected from a 6-membered ring or a fused multi-ring system;
wherein when A is a 6-membered ring the carboxylate side chains are in the 2,5 position; and
wherein n1 and n2 are integers independently selected from the range 0 to 20.

24. A method according to claim 23, wherein step (a) comprises dissolving in water, as another of the plural chemically different linkers, a second linker having the following general formula: 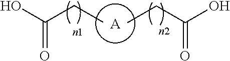
wherein A is a heteroaryl or heterocycloalkyl ring or ring system selected from a 6-membered ring or a fused multi-ring system;
wherein when A is a 6-membered ring the carboxylate side chains are in the 2,5 position; and
wherein n1 and n2 are integers independently selected from the range 0 to 20.

25. A method according to claim 24, wherein step (a) comprises dissolving the first linker and the second linker in water simultaneously or consecutively.

26. (canceled)

27. A method according to claim 21, wherein step (c) comprises heating the mixture to a temperature in the range 30 to 100° C. from 4 to 72 hours.

28. (canceled)

29. A method according to claim 21, further comprising activating the porous metal-organic framework by:
(i) contacting the crystalline material with deionized water;
(ii) contacting the crystalline material with methanol; and
(iii) heating the crystalline material.

30. A method according to claim 29, wherein:
at least one of step (i) and step (ii) comprises soaking the crystalline material for a period of 4 mins to 24 hours; and
step (iii) comprises heating the crystalline material to 40 to 100° C. for 1 min to 2 hours, then to 40 to 150° C. for 10 min to 2 hours, then to 60° C. for 10 min to 2 hours.

31. (canceled)

32. A porous metal-organic framework comprising a metal and plural chemically different linkers, formed by the method of claim 21.
